(19) United States
(12) Patent Application Publication
(10) Pub. No.: US 2011/0064863 A1
(43) Pub. Date: Mar. 17, 2011

(54) Mixture of Olive Oils

(75) Inventor: Alissa Mattei, Gavorrano (GR) (IT)

(73) Assignee: OLITALIA S.r.l.

(21) Appl. No.: 12/590,177

(22) Filed: Nov. 18, 2010

(30) Foreign Application Priority Data
Jun. 26, 2009 (IT) MO2009A000168

(51) Int. Cl. A23D 9/00

(52) U.S. Cl. 426/601

(57) ABSTRACT

The mixture of olive oils comprises a first monovarietal extra-virgin olive oil and a second monovarietal extra-virgin olive oil mixed together and selected from the list comprising: Picual, Coratina, Cornicabra and Moraiolo.

### CROSS REFERENCE TO RELATED APPLICATIONS

Applicant claims priority under 35 U.S.C. §119 of Italian Application No. MO2009A000168 filed on Jun. 26, 2009.

### TECHNICAL FIELD

The present invention relates to a mixture of olive oils.

### BACKGROUND ART

As is known, extra virgin olive oil is made from the fruit of the olive tree (drupe) by means of physical and mechanical treatments only in predetermined and controlled heat conditions.

The oil contained in the drupe is generally made up on average of 99% triglycerides and 1% of many minor components that characterise the taste and smell of extra virgin olive oil.

Among these components are the tocopherols (among which a-tocopherol called vitamin E) and the biophenols which are polar substances that, during the pressing process, split up into vegetation waters and oil.

Both the tocopherols and the biophenols are major natural antioxidants which can be useful for preventing the oxidisation of lipoproteins and for reducing free radicals, as well as providing positive biomedical effects at cardiovascular level, in combating illnesses tied to old age and stopping tumour growth.

To this must be added that the stability of the extra virgin olive oil is tied to the presence of anti-oxidants and, therefore, oils with high contents of tocopherols and biophenols better preserve their chemical-physical and organoleptic profile over time, showing greater stability.

Tocopherols are major components of antioxidants and are a decisive factor in ensuring the stability of the oil and it appears that they play a synergic role with respect to the biophenols themselves. The best represented tocopherol in olive oil is α-tocopherol, which can reach up to 90%.

Also very efficient are the biophenols which, unlike the tocopherols, perform their action not only in lipidic environment but also in aqueous environment.

The biophenols present in olive oil are usually split into several classes including Hty (hydroxytyrosol), Ty (tyrosol), DMO-DA (dialdehydic form of decarboxymethyl oleuropein), DML-DA (dialdehydic form of decarboxymethyl ligstroside), O-AGL (oleuropein aglycone), L-AGL (ligstroside aglycone) and lignans.

These classes of biophenols not only affect the antioxidant properties of the oil, but also its quality and flavour, such as, e.g. its bitterness and/or astringency.

As is known, for example, Hty and Ty are derived by hydrolysis from the components with high molecular weight and their presence evaluated in percentage with respect to the overall quantity of biophenols provides an indication of the state of health of the oil (% of hydrolysis).

It has also been proven that an oil rich in DMO-DA and DML-DA has a fruitier taste, just as the sum of DMO-DA and O-AGL provides a more significant index of actual resistance to oxidisation. In particular, the total orthodiphenols, expressed as the sum of the derivates of hydroxytyrosol (DMO-DA, O-AGL) added to the hydroxytyrosol itself (Hty), are directly correlated to resistance to oxidisation.

The olive oils available on the market are usually characterised by quantities of biophenols very different the one from the other, generally depending on their origin and on pressing methods, on the ripeness of the olives, on the type of soil and on the microclimate.

In practice, the olive oil commonly found on the market is split into:
monovarietal oil, meaning at least 90-95% is obtained from drupes from the same variety or cultivar;
multivarietal oil, meaning mixes of different olive oils obtained from different varieties or cultivars but which have in common the fact that they all come from the same country; mixes of Italian oils, Spanish oils, etc. exist.

While on the one hand, multivarietal oils usually have a standard quality and an average quantity of biophenols, on the other hand, monovarietal oils can also be distinguished by a high overall level of biophenols, but it often occurs that such substances are only concentrated in some of the above mentioned biophenol classes with the risk, in the end, of the chemical/physical characteristics and/or organoleptic characteristics of the oil not being exceptional.

### OBJECT OF THE INVENTION

The main aim of the present invention is to provide a mixture of olive oils with high quality, both in terms of organoleptic and anti-oxidising properties.

A further object of the present invention is to obtain a mixture of olive oils that not only has a particularly high overall biophenol content, but in which the biophenols are also distributed in a uniform and balanced manner between the various classes of compounds.

Furthermore, an object of the invention is also to ensure a high sum of the antioxidant compounds of the lipophyl type (tocopherols) and hydrophyl type (biophenols), such as to ensure exceptional stability.

Another object of the present invention is to provide a mixture of olive oils which allows to overcome the mentioned drawbacks of the known art in the ambit of a simple, rational, easy and low cost solution.

The above objects are achieved by the present mixture of olive oils, characterized by the fact that it comprises at least a first monovarietal olive oil and at least a second monovarietal olive oil mixed together and selected from the list comprising: Picual, Coratina, Cornicabra and Moraiolo.

### BRIEF DESCRIPTION OF THE DRAWINGS

Further characteristics and advantages of this invention will appear more evident from the description of the embodiment of mixture of olive oils illustrated indicatively in the attached drawings wherein:

FIG. 1 is a graph showing the data of the table 1 according to the invention;

FIG. 2 is a graph showing the data of the table 2 according to the invention;

FIG. 3 is a graph showing the data of the tables 3 and 4 according to the invention;

FIG. 4 is a graph showing the data of the tables 5 and 6 according to the invention;

FIG. 5 is a graph showing the concentrations of biophenols, orthodiphenols and tocopherols in the two oils according to the invention;

FIG. 6 is a graph showing the data of the table 7 according to the invention;

FIG. 7 is a graph showing the data of the table 8 according to the invention;

FIG. 8 is a graph showing the concentrations of biophenols, orthodiphenols and tocopherols in the mixture of oils according to the invention.

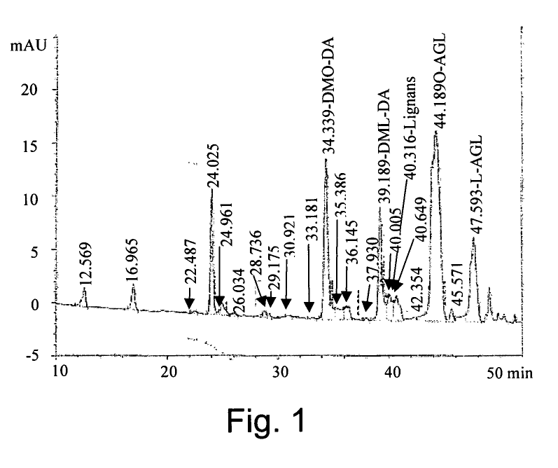

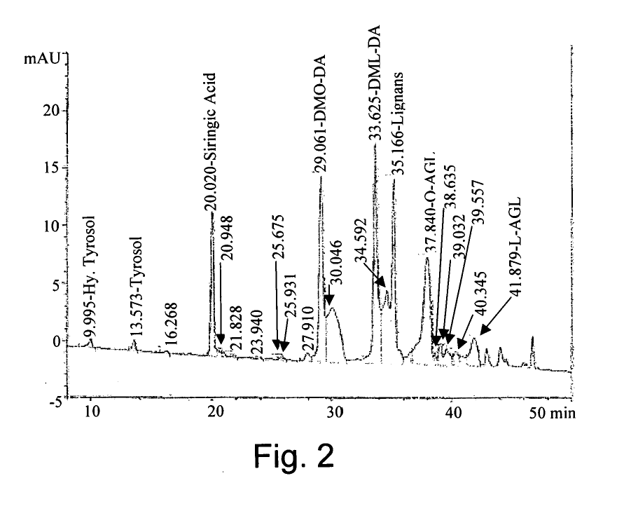

### EMBODIMENTS OF THE INVENTION

In particular, both the first olive oil and the second olive oil are of the extra-virgin type and preferably the first olive oil is selected from the list comprising Picual and Cornicabra, while the second olive oil is selected from the list comprising Coratina and Moraiolo.

In particular, the first olive oil and the second olive oil are mixed in the following weight concentrations evaluated with respect to the total weight of the mixture:

| | |
|---|---|
| first olive oil | 20-80% |
| second olive oil | 80-20% |

and preferably in the following weight concentrations evaluated with respect to the total weight of the mixture:

| | |
|---|---|
| first olive oil | 40-60% |
| second olive oil | 60-40% |

In particular, the first olive oil and the second olive oil are present in concentrations substantially equal to 50% of the total weight of the mixture.

### EXAMPLE 1

Below is a detailed description of a mixture of olive oils in which the first olive oil comes from the cultivar Picual while the second olive oil comes from the cultivar Coratina mixed together in concentrations substantially equal to 50% of the total weight of the mixture.

Alternative embodiments of the present invention cannot however obviously be ruled out in which, on the other hand, the first olive oil and the second olive oil are Cornicabra and Moraiolo, and/or are mixed together in ratios other than 50%.

For this purpose, it is pointed out that the Tables 1 and 2 show the biophenolic profiles of Picual and Coratina respectively, evaluated using the measuring system called HPLC (Cortesi and Rovellini method) accepted at international level (International Olive Oil Council) as an instrument for detecting the quantitative and qualitative profile of biophenols contained in the olive oil.

From the data shown on the Tables 1 and 2, it can be seen that the overall biophenolic content of Picual amounts to 478 mg/kg while that of Coratina amounts to 492 mg/kg.

TABLE 1

| | | | | | | | Compound |
|---|---|---|---|---|---|---|---|
| # | Meas | Width | Peak | Height | Area % | Area | Name |
| 1 | 0.000 | 0.000 | | 0.000 | 0.000 | 0.00 | Hy. Tyrosol |
| 2 | 12.569 | 0.348 | MM | 1.869 | 1.562 | 39.03 | |
| 3 | 0.000 | 0.000 | | 0.000 | 0.000 | 0.00 | Tyrosol |
| 4 | 16.965 | 0.300 | MM | 2.501 | 1.800 | 44.97 | |
| 5 | 22.487 | 0.428 | FM | 0.215 | 0.221 | 5.51 | |
| 6 | 0.000 | 0.000 | | 0.000 | 0.000 | 0.00 | Siringic Acid |
| 7 | 24.025 | 0.263 | MF | 11.818 | 7.453 | 186.27 | |
| 8 | 24.961 | 0.441 | MF | 1.134 | 1.201 | 30.00 | |
| 9 | 26.034 | 0.356 | FM | 0.240 | 0.205 | 5.12 | |
| 10 | 28.736 | 0.278 | MF | 0.768 | 0.513 | 12.82 | |
| 11 | 29.175 | 0.253 | MF | 0.417 | 0.253 | 6.33 | |
| 12 | 30.921 | 0.491 | MM | 0.173 | 0.204 | 5.09 | |
| 13 | 33.181 | 0.450 | MM | 0.111 | 0.119 | 2.99 | |
| 14 | 34.339 | 0.414 | MF | 15.150 | 15.045 | 375.99 | DMO-DA |
| 15 | 35.386 | 0.683 | FM | 1.037 | 1.699 | 42.47 | |
| 16 | 36.145 | 0.532 | FM | 1.316 | 1.679 | 41.96 | |
| 17 | 37.930 | 0.341 | MM | 0.254 | 0.208 | 5.21 | |
| 18 | 39.189 | 0.405 | MF | 10.698 | 10.394 | 259.75 | DML-DA |
| 19 | 40.005 | 0.332 | MF | 2.912 | 2.320 | 57.99 | |
| 20 | 40.316 | 0.203 | MF | 1.862 | 0.906 | 22.63 | Lignans |
| 21 | 40.649 | 0.539 | MF | 2.389 | 3.091 | 77.25 | |
| 22 | 42.364 | 0.276 | MF | 0.452 | 0.300 | 7.49 | |
| 23 | 44.189 | 0.874 | MF | 17.965 | 37.689 | 941.89 | O-AGL |
| 24 | 45.571 | 0.332 | MF | 1.201 | 0.957 | 23.93 | |
| 25 | 47.593 | 0.636 | FM | 7.973 | 12.180 | 304.39 | L-AGL |
| | | | | | 100.000 | 2499.09 | |

TABLE 2

| | | | | | | | Compound |
|---|---|---|---|---|---|---|---|
| # | Meas | Width | Peak | Height | Area % | Area | Name |
| 1 | 9.995 | 0.344 | MM | 0.814 | 0.601 | 16.78 | Hy. Tyrosol |
| 2 | 13.573 | 0.289 | MM | 1.005 | 0.623 | 17.40 | Tyrosol |
| 3 | 16.268 | 0.357 | MM | 0.212 | 0.162 | 4.53 | |
| 4 | 20.020 | 0.255 | MF | 12.578 | 6.906 | 192.79 | Siringic Acid |
| 5 | 20.948 | 0.276 | FM | 0.440 | 0.261 | 7.28 | |
| 6 | 21.828 | 0.284 | FM | 0.289 | 0.176 | 4.92 | |
| 7 | 23.940 | 0.252 | MM | 0.243 | 0.131 | 3.67 | |
| 8 | 25.675 | 0.268 | MF | 0.232 | 0.134 | 3.73 | |
| 9 | 25.931 | 0.192 | FM | 0.198 | 0.082 | 2.29 | |
| 10 | 27.910 | 0.541 | FM | 0.839 | 0.975 | 27.22 | |
| 11 | 29.061 | 0.407 | FM | 16.270 | 14.246 | 397.68 | DMO-DA |
| 12 | 30.046 | 1.202 | FM | 4.811 | 12.426 | 346.90 | |
| 13 | 33.625 | 0.428 | MF | 19.267 | 17.736 | 495.13 | DML-DA |
| 14 | 34.592 | 0.656 | MF | 6.476 | 9.132 | 254.92 | |
| 15 | 35.166 | 0.338 | FM | 16.231 | 11.803 | 329.49 | Lignans |
| 16 | 37.940 | 0.766 | FM | 9.448 | 15.553 | 434.18 | O-AGL |
| 17 | 38.635 | 0.254 | FM | 1.120 | 0.611 | 17.06 | |
| 18 | 39.032 | 0.248 | FM | 3.058 | 1.627 | 45.42 | |
| 19 | 39.557 | 0.519 | FM | 1.489 | 1.661 | 46.38 | |
| 20 | 40.345 | 0.461 | FM | 1.245 | 1.235 | 34.49 | |
| 21 | 41.879 | 0.719 | FM | 2.536 | 3.917 | 109.36 | L-AGL |
| | | | | | 100.000 | 2791.61 | |

The biophenolic profiles illustrated in the Tables 1 and 2, furthermore, allow obtaining the values of biophenols contained in Picual and Coratina split into classes, which are shown in the Tables 3 and 4.

TABLE 3

| Picual | mg/kg |
|---|---|
| Hty | 8 |
| Ty | 9 |
| DMO-DA | 78 |
| DML-DA | 54 |
| Lignani | 16 |
| O-AGL | 194 |
| L-AGL | 63 |

TABLE 4

| Coratina | mg/kg |
|---|---|
| Hty | 3 |
| Ty | 3 |
| DMO-DA | 75 |
| DML-DA | 91 |
| Lignani | 58 |
| O-AGL | 82 |
| L-AGL | 22 |

The data of the Tables 3 and 4 can be grouped into the following groups of biophenol classes: (DMO-DA+DML-DA), (O-AGL+L-AGL), (DMO-DA+O-AGL), (DML-DA+L-AGL) and orthodiphenols (DMO-DA+O-AGL+Hty).

The biophenolic contents of such classes are illustrated below on the Tables 5 and 6.

TABLE 5

| Picual | mg/kg |
|---|---|
| (Hty + Ty) | 17 |
| (DMO-DA) + (DML-DA) | 132 |
| (O-AGL) + (L-AGL) | 257 |
| (DMO-DA) + (O-AGL) | 272 |
| (DML-DA) + (L-AGL) | 117 |
| Ortodiphenols (DMO-DA + O-AGL + Hty) | 280 |

TABLE 6

| Coratina | mg/kg |
|---|---|
| (Hty + Ty) | 6 |
| (DMO-DA) + (DML-DA) | 166 |
| (O-AGL) + (L-AGL) | 104 |
| (DMO-DA) + (O-AGL) | 157 |
| (DML-DA) + (L-AGL) | 113 |
| Ortodiphenols (DMO-DA + O-AGL + Hty) | 160 |

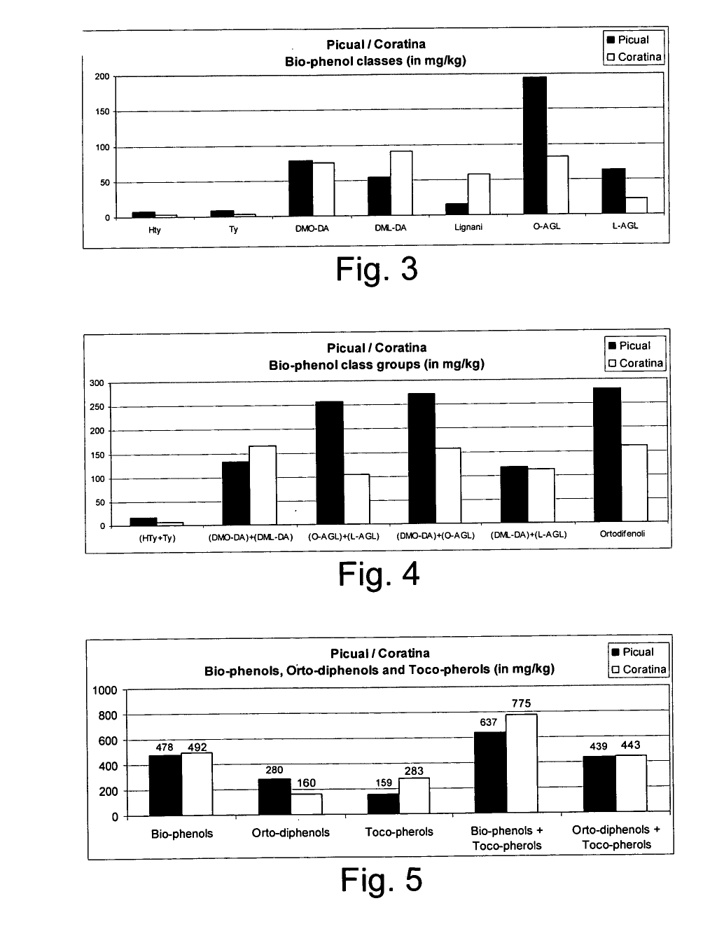

The data of the Tables 3 and 4 are shown graphically in the FIG. 3 while those of the Tables 5 and 6 are shown in the subsequent FIG. 4.

With reference to the tocopherol content, it is pointed out that Picual contains a quantity equal to 159 mg/kg while Coratina contains 283 mg/kg.

Comparing the concentrations of overall biophenols, orthodiphenols and tocopherols, the results are obtained shown on FIG. 5, in which the tocopherols are expressed both individually and in combination with the quantities of biophenols and orthodiphenols to provide more significant details of the overall anti-oxidising properties of the two oils.

Now taking into consideration the mixture (Blending) made up of 50% Picual and 50% Coratina, it is underlined that such mixture is characterised by an overall concentration of biophenols above 400 mg/kg and substantially equal to 485 mg/kg and a concentration of orthodiphenols (DMO-DA+O-AGL+Hty) above 200 mg/kg and substantially equal to 220 mg/kg.

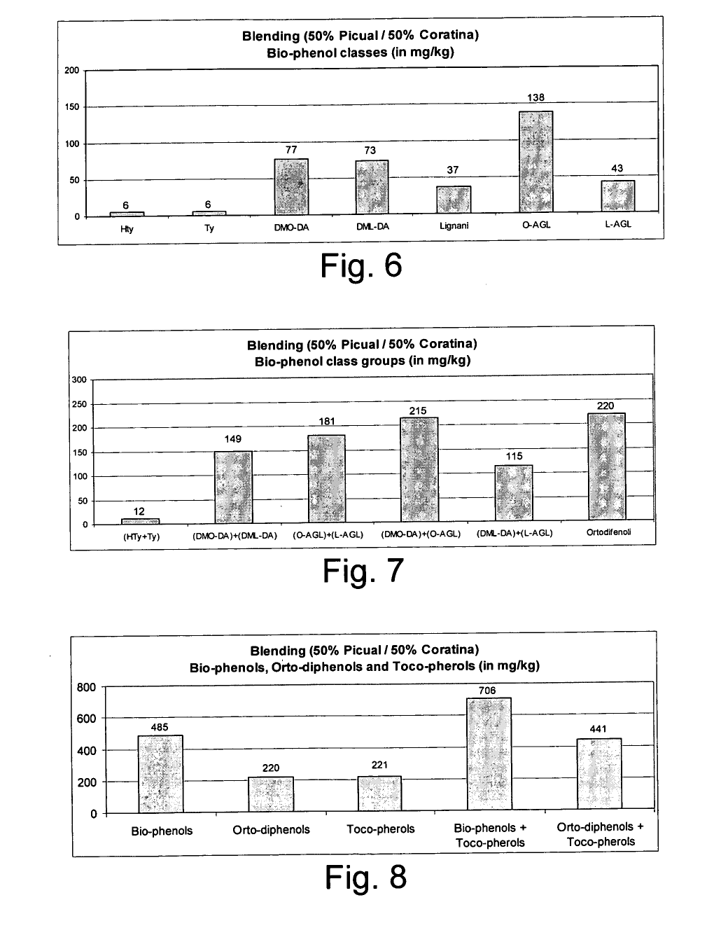

The data relating to the classes of biophenols and to the above-mentioned groups of biophenol classes for the mixture according to the invention are shown on the Tables 7 and 8 and shown graphically on the FIG. 6 and FIG. 7.

TABLE 7

| Blending | mg/kg |
|---|---|
| Hty | 6 |
| Ty | 6 |
| DMO-DA | 77 |
| DML-DA | 73 |
| Lignani | 37 |
| O-AGL | 138 |
| L-AGL | 43 |

TABLE 8

| Blending | mg/kg |
|---|---|
| (Hty + Ty) | 12 |
| (DMO-DA) + (DML-DA) | 150 |
| (O-AGL) + (L-AGL) | 180 |
| (DMO-DA) + (O-AGL) | 215 |
| (DML-DA) + (L-AGL) | 115 |
| Ortodiphenols (DMO-DA + O-AGL + Hty) | 220 |

From the data shown above, it can be determined that all the groups of biophenol classes (DMO-DA+DML-DA), (O-AGL+L-AGL), (DMO-DA+O-AGL) and (DML-DA+L-AGL) show a concentration of biophenols above 100 mg/kg.

This means that the biophenols present in the mixture according to the invention are distributed in a balanced way and guarantee the high quality of the oil, both in terms of organoleptic properties and anti-oxidising capacities.

It is further underlined that the content of Hty and Ty in this mixture is particularly limited if compared with the overall quantity of biophenols present, which goes to show the good health and freshness of the oil.

Now also taking into consideration the tocopherol content, it is pointed out that their concentration in the mixture (Blending) is over 200 mg/kg and substantially equal to 221 mg/kg.

The comparison between the data relating to biophenols, orthodiphenols and tocopherols in the mixture according to the invention is shown in the FIG. 8, from which it can be determined that the sum of the biophenols and tocopherols is over 550 mg/kg and substantially equal to 706 mg/kg, while the sum of orthodiphenols and tocopherols is above 300 mg/kg and substantially equal to 441 mg/kg.

Such overall data make it possible to appreciate the considerable anti-oxidising capacities of the mixture according to the invention which is thus able to preserve its organoleptic properties over time.

To preserve the quality of the mixture according to the invention even longer, it is preferable to adopt the following fabrication procedure which comprises the following phases:
to supply the first olive oil and the second olive oil;
to mix the first olive oil and the second olive oil and obtain the mixture of olive oils; and
to blow into the mixture an inert gas, which is preferably nitrogen.

Advantageously, this blowing phase is done at the same time as mixing. This procedure reduces the quantity of oxygen of the mixture, inside the oil, which would, sooner or later, determine the oxidisation of the biophenols as anti-oxidants and the reduction of their effectiveness and of their properties. Taking into account the need to obtain a mixture of olive oils with high biophenol content by mixing two oils selected from Picual, Coratina, Cornicabra and Moraiolo, the particular solution of blowing nitrogen during mixing permits preserving the mixture over time and in particular its organoleptic and anti-oxidising properties.

1. Mixture of olive oils, comprising at least a first monovarietal extra-virgin olive oil and at least a second monovarietal extra-virgin olive oil mixed together and selected from the list comprising: Picual, Coratina, Cornicabra and Moraiolo.

2. Mixture according to claim 1, wherein said first olive oil is selected from the list comprising Picual and Cornicabra, and said second olive oil is selected from the list comprising Coratina and Moraiolo.

3. Mixture according to claim 1, wherein said first olive oil is Picual and said second olive oil is Coratina.

4. Mixture according to claim 1, wherein the mixture comprises said first olive oil and said second olive oil in the following weight concentrations evaluated with respect to the total weight of the mixture:

| | |
|---|---|
| first olive oil | 20-80% |
| second olive oil | 80-20% |

5. Mixture according to claim 1, wherein the mixture comprises said first olive oil and said second olive oil in the following weight concentrations evaluated with respect to the total weight of the mixture:

| | |
|---|---|
| first olive oil | 40-60% |
| second olive oil | 60-40% |

6. Mixture according to claim 1, wherein said first olive oil and said second olive oil are mixed together in concentrations substantially equal to 50% of the total weight of the mixture.

7. Mixture according to claim 1, wherein the mixture comprises an overall concentration of total biophenols above 400 mg/kg.

8. Mixture according to claim 1, wherein the mixture comprises an overall concentration of total biophenols substantially equal to 485 mg/kg.

9. Mixture according to claim 1, wherein the mixture comprises an overall concentration of orthodiphenols above 200 mg/kg.

10. Mixture according to claim 1, wherein the mixture comprises an overall concentration of orthodiphenols substantially equal to 220 mg/kg.

11. Mixture according to claim 1, wherein the mixture comprises an overall concentration of tocopherols above 200 mg/kg.

12. Mixture according to claim 1, wherein the mixture comprises an overall concentration of tocopherols substantially equal to 221 mg/kg.

13. Mixture according to claim 1, wherein the mixture comprises at least a group of classes of biophenols selected between (DMO-DA+DML-DA), (O-AGL+L-AGL), (DMO-DA+O-AGL) and (DML-DA+L-AGL) having a concentration of biophenols above 100 mg/kg.

14. Mixture according to claim 1, wherein each of said groups of classes of biophenols (DMO-DA+DML-DA), (O-AGL+L-AGL), (DMO-DA+O-AGL) and (DML-DA+L-AGL) has a concentration of biophenols above 100 mg/kg

15. Process for obtaining a mixture of olive oils, comprising the phases of:
supplying at least a first monovarietal extra-virgin olive oil and at least a second monovarietal extra-virgin olive oil selected from the list comprising:
Picual, Coratina, Cornicabra and Moraiolo;
mixing said first olive oil and said second olive oil to obtain a mixture of olive oils.

16. Process according to claim 15, wherein said first olive oil is selected from the list comprising Picual and Cornicabra, and said second olive oil is selected from the list comprising Coratina and Moraiolo.

17. Process according to claim 15, wherein said first olive oil is Picual and said second olive oil is Coratina.

18. Process according to claim 15, wherein said first olive oil and said second olive oil are mixed in the following weight concentrations evaluated with respect to the total weight of the mixture:

| | |
|---|---|
| first olive oil | 20-80% |
| second olive oil | 80-20% |

19. Process according to claim 15, wherein said first olive oil and said second olive oil are mixed in the following weight concentrations evaluated with respect to the total weight of the mixture:

| | |
|---|---|
| first olive oil | 40-60% |
| second olive oil | 60-40% |

20. Process according to claim 15, wherein said first olive oil and said second olive oil are mixed together in concentrations substantially equal to 50% of the total weight of the mixture.

21. Process according to claim 15, wherein the process comprises the phase of blowing at least an inert gas into said mixture.

22. Process according to claim 15, wherein said blowing in occurs at the same time as said mixing.

23. Process according to claim 15, wherein said inert gas comprises nitrogen.

24. Mixture of olive oils, comprising at least a first monovarietal extra-virgin olive oil and at least a second monovarietal extra-virgin olive oil mixed together, wherein the overall concentration of total biophenols is above 400 mg/kg.
